(19) United States
(12) Patent Application Publication
(10) Pub. No.: US 2005/0198579 A1
(43) Pub. Date: Sep. 8, 2005

(54) Method and apparatus to avoid duplicate electronic mail documents resulting from forwarding of an electronic mail document

(75) Inventors: Bhargav V. Perepa, Austin, TX (US); Sujatha Perepa, Austin, TX (US); Shyamala Vishwanath, Austin, TX (US); Venkataramappa Vishwanath, Austin, TX (US)

Correspondence Address: Janis E. Clements, 3601 Moon River Road, Austin, TX, 78746, US

(73) Assignee: International Business Machines Corporation, Armonk, NY (US)

(21) Appl. No.: 10/793,468

(22) Filed: Mar. 4, 2004

(51) Int. Cl. G06F 3/00; G06F 15/16

(52) U.S. Cl. 715/752; 715/733; 715/739; 715/789; 715/811; 709/200

(57) ABSTRACT

A display interface at a sending terminal including the conventional means enabling the sender of an electronic mail document to specify recipients to receive the document, but, in addition, provides means enabling the forwarder of the electronic mail document to determine whether a recipient has previously received the electronic mail document. An inventory of duplicate mail recipients is provided to the forwarder of the document in the form of a hidden list of recipients who have previously received the E-mail document. This hidden list is updated as the document is forwarded. The forwarder can select to forward the duplicate mail or discard the duplicate mail automatically. This invention also allows the forwarder of the E-mail document to remove recipients from a distribution list who have previously received the document.

### TECHNICAL FIELD

The present invention relates to computer managed communication networks, such as the World Wide Web (Web), and particularly to electronic mail (E-mail) messages transmitted over such networks to display terminals.

### BACKGROUND OF RELATED ART

The past decade has been marked by a technological revolution driven by the convergence of the data processing industry with the consumer electronics industry. The effect has, in turn, driven technologies that have been known and available but relatively quiescent over the years. A major one of these technologies is the Internet or Web related distribution of documents. The Web or Internet, which had quietly existed for over a generation as a loose academic and government data distribution facility, reached “critical mass” and commenced a period of phenomenal expansion. With this expansion, businesses and consumers have direct access to all matter of documents and media through the Web. Also, as a result of the rapid expansion of the Web, E-mail, which has been distributed for over 25 years over smaller private and specific purpose networks, has moved into distribution over the Web because of the vast distribution channels that are available.

The availability of extensive E-mail distribution channels has made it possible to keep all necessary parties in business, government and public organizations completely informed of all transactions that they need to know about at almost nominal costs. However, there can be too much of a good thing. The availability of inexpensive E-mail has led to an undesirable proliferation of E-mail that many executive, management, professional and technical individuals are forced to handle. Our concern for this proliferation of E-mail is not directed to conventional junk mail, i.e. E-mail with subject matter in which the receiver has little or no interest. There are currently available a variety of application programs by which the user may filter out undesirable junk mail through the application of selected criteria appropriate to the user.

The E-mail subject matter creating the proliferation to which the present invention is directed is often subject matter of great interest to the parties receiving copies or forwards of the E-mail documents. However, it is completely unnecessary to send copies of the E-mail to individuals who have already received the original E-mail. For example, when an E-mail is sent using a distribution list that does not reveal all of the recipients, a recipient may unnecessarily forward the E-mail to those recipients who were on the distribution list and had already received the E-mail. In this case, an E-mail may be sent or forwarded to one or more recipients more than once by unknowing recipients of the same E-mail who then forward the E-mail to other recipients. If each recipient of an E-mail forwards the E-mail not knowing it was already received by other recipients, the same E-mail can be received as many times as there are recipients on the distribution list.

This problem of duplicate E-mail is not limited to cases where a distribution list is used to send the original E-mail. Even in cases where the original E-mail was sent using explicit recipient addresses, a recipient may overlook the addresses and forward the E-mail using the recipient's own distribution list, which can result in duplicate E-mail being sent to recipients who previously received the E-mail. It is the frequent lament of management people that they have to spend hours upon hours going through often unnecessary duplicate E-mail.

Most current E-mail applications do provide for a blanket “Do Not Copy” to completely preclude the copying of particularly sensitive E-mail documents, but such an expedient is not a solution to the problems described above.

### SUMMARY OF THE PRESENT INVENTION

The present invention provides an electronic mail distribution system for a network, e.g. Internet E-mail transmitted between interactive display terminals. The invention offers a solution to the above problems by providing a display interface at a sending terminal including the conventional means for enabling a sender of an electronic mail document to determine if the E-mail has been previously delivered to one or more of the recipients. Because there are several levels of “sending” of an E-mail document covered by this invention, for the sake of clarity, the original sender of the original E-mail document is herein referred to as “sender” or “A”. The recipient who then forwards the E-mail document received from “sender” or “A” is herein referred to as “forwarder”, “B”, or in some cases, “recipient B”.

The present invention provides means for discarding a duplicate E-mail message. This invention provides an inventory of duplicate E-mail recipients in a hidden list within the E-mail document. This invention provides an inventory of duplicate mail recipients to a forwarder of the duplicate mail. The forwarder of the mail can select to forward the duplicate mail or discard it. A forwarder can have duplicate E-mails discarded automatically. This invention filters duplicate mail at the server and works with a distribution list to determine which recipients from the distribution list have already received the E-mail. Once this determination is made, the forwarder is notified of those intended recipients who have already received the mail, and also notified with a list of recipients who were and were not sent the mail by the forwarder, depending on whether the forwarder has selected to send or “Remove Duplicates.”

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a block diagram of a data processing system including a central processing unit and network connections via a communications adapter that is capable of implementing the interactive display terminals, as well as servers in the Internet or Web E-mail distribution of this invention;

FIG. 2 is a generalized view of an E-mail distribution system in a Web or Internet that may be used in the practice of the present invention;

FIG. 3 is a diagrammatic illustration of an interactive display interface used for the writing of an E-mail document;

FIG. 4 is the display interface of FIG. 3 after the sender has selected to send the E-mail and is prompted for individuals to copy to;

FIG. 5 is the display interface like that of FIG. 4 after recipient “B” has selected to forward the E-mail and is advised of the selected individuals who have already received the E-mail;

FIG. 6 is the display interface of FIG. 3 after the sender has selected to send the E-mail and is prompted for individuals to copy to (in this diagram, a first distribution list, Group 1, is selected);

FIG. 7 is the display interface like that of FIG. 6 after Group 1 recipient “B” has selected to forward the E-mail to individuals on a second distribution list, Group 2, and is advised of which individuals from the second distribution list, Group 2, have already received the E-mail;

FIG. 8 is a flowchart of an illustrative run of Phase I of the program set up according to FIG. 7, wherein an original E-mail is sent to a recipient;

FIG. 9 is a flowchart of an illustrative run of Phase II of the program set up according to FIG. 7, wherein an original E-mail recipient (“B”) forwards the E-mail to other recipients;

FIG. 10 is a flowchart of an illustrative run of Phase III of the program set up according to FIG. 7, wherein the original E-mail is sent to recipients on a distribution list; and

FIG. 11 is a flowchart of an illustrative run of Phase IV of the program set up according to FIG. 7, wherein the original E-mail distribution list recipient (“B”) forwards the E-mail to other distribution list recipients.

### DETAILED DESCRIPTION OF THE PREFERRED EMBODIMENT

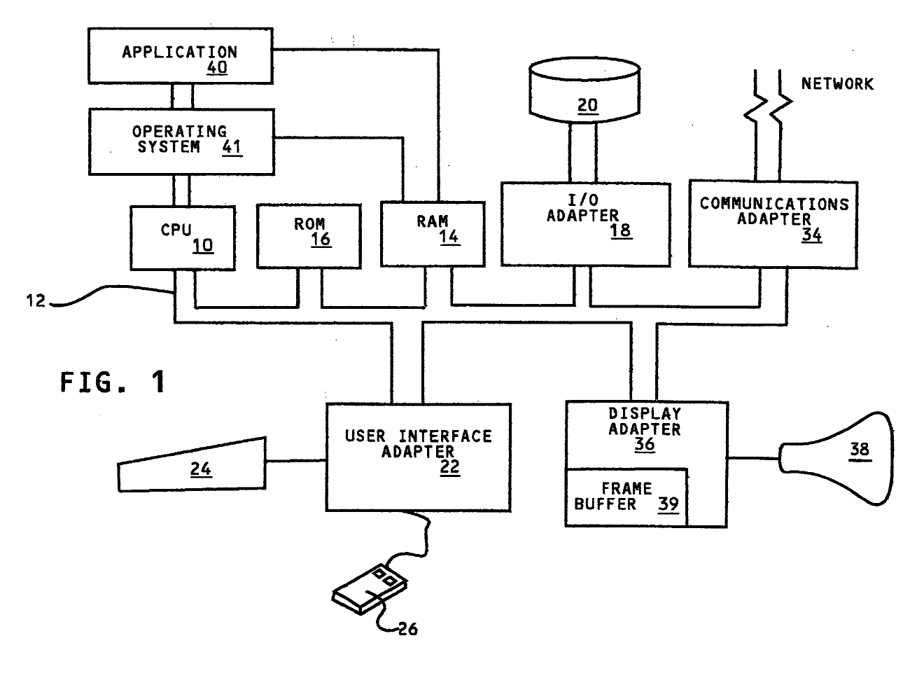

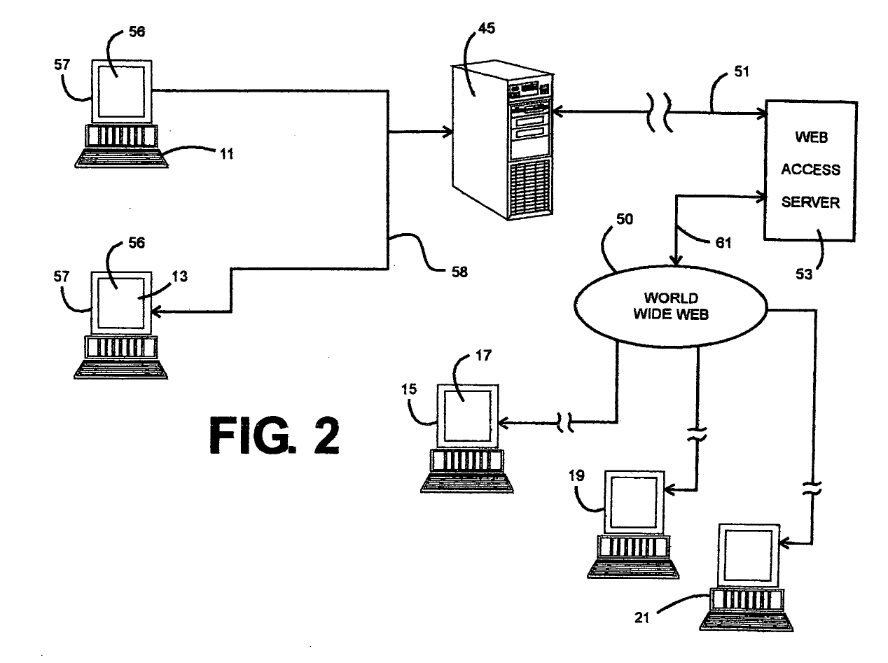

Referring to FIG. 1, a typical data processing system is shown that may function as the computer controlled network terminals or Web stations used conventionally as any of the sending or receiving Web stations for electronic mail transmission. The system shown is also illustrative of any of the server computers used for the Web E-mail distribution to be described in greater detail with respect to FIG. 2.

A central processing unit (CPU) 10, may be one of the commercial microprocessors in personal computers available from numerous computer companies, such as International Business Machines Corporation (IBM); when the system shown is used as a server computer at the Web distribution site to be subsequently described, then a workstation is preferably used, e.g. RISC System/6000™ (RS/6000) series available from IBM. The CPU 10 is interconnected to various other components by system bus 12. An operation system 41 runs on CPU 10, provides control and is used to coordinate the function of the various components of FIG. 1. Operating system 41 may be one of the commercially available operating systems such as the AIX 6000™ operating system available from IBM; Microsoft's Windows XP™ or Windows2000™, as well as UNIX and AIX operating systems. Application programs 40, controlled by the system, are moved into and out of the main memory Random Access Memory (RAM) 14. These programs include the programs of the present invention for enabling senders of E-mail documents to determine whether individuals have already received the E-mail being forwarded, and selecting to discard or send the duplicate E-mail. Where the computer system shown functions as the receiving Web station, then any conventional Web browser application program, such as Microsoft's Internet Explorerm, will be available for accessing E-mail from the Web and for sending E-mail to the Web from the network station. A Read Only Memory (ROM) 16 is connected to CPU 10 via bus 12 and includes the Basic Input/Output System (BIOS) that controls the basic computer functions. RAM 14, I/O adapter 18 and communications adapter 34 are also interconnected to system bus 12. I/O adapter 18 communicates with the disk storage device 20. Communications adapter 34 interconnects bus 12 with the outside network enabling the computer system to communicate with other such computers over the Web or Internet. The latter two terms are meant to be generally interchangeable and are so used in the present description of the distribution network. I/O devices are also connected to system bus 12 via user interface adapter 22 and display adapter 36. Keyboard 24 and mouse 26 are all interconnected to bus 12 through user interface adapter 22. It is through such input devices that the user at a receiving station may interactively relate to the Web in order to access Web documents. Display adapter 36 includes a frame buffer 39 that is a storage device that holds a representation of each pixel on the display screen 38. Images may be stored in frame buffer 39 for display on monitor 38 through various components, such as a digital to analog converter (not shown) and the like. By using the aforementioned I/O devices, a user is capable of inputting information to the system through the keyboard 24 or mouse 26 and receiving output information from the system via display 38.

Before going further into the details of specific embodiments, it will be helpful to understand from a more general perspective the various elements and methods that may be related to the present invention. Because a major aspect of the present invention is directed to E-mail documents transmitted over networks, an understanding of networks and their operating principles would be helpful. Reference has also been made to the applicability of the present invention to a global network, such as the Internet or Web. For details on Internet nodes, objects and links, reference is made to the text, Mastering the Internet, G. H. Cady et al., published by Sybex Inc., Alameda, Calif., 1996. The Internet or Web is a global network of a heterogeneous mix of computer technologies and operating systems. Higher level objects are linked to the lower level objects in the hierarchy through a variety of network server computers. E-mail is distributed through such a network.

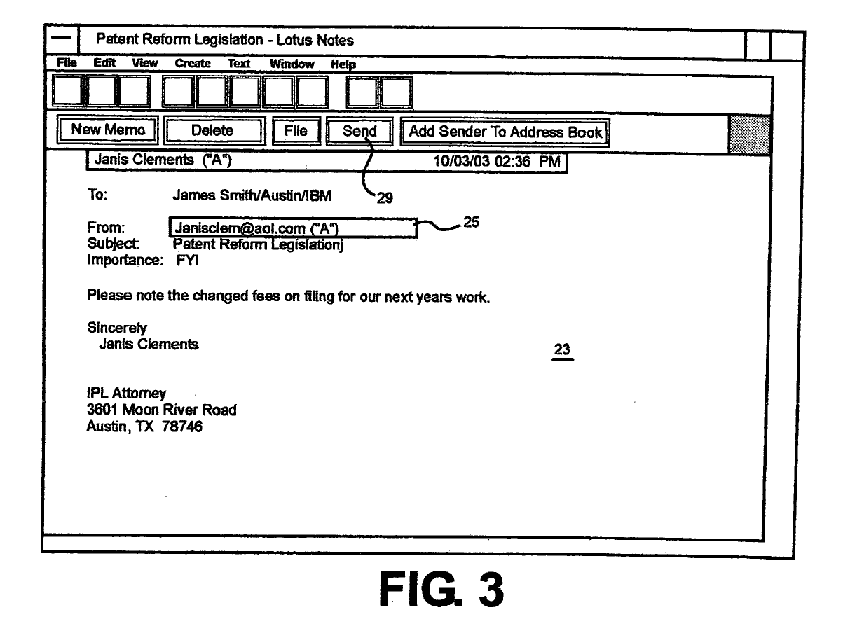

A generalized diagram of a portion of the Web for illustration of the E-mail distribution system of the present invention is shown in FIG. 2. The computer controlled display terminals 11 and 13 have displays 57 upon which E-mail documents 56 may be created by senders and displayed. Terminals 11 and 15 may be implemented by the computer system setup in FIG. 1. For purposes of the present embodiment, terminals 11 and 13 serve as a Web display station for sending of E-mail via the display interfaces to be described with respect to FIGS. 3 through 7 via Web browser programs. Reference may be made to the above-mentioned Mastering the Internet, pp. 136-147, for typical connections between local display stations to the Web via network servers, any of which may be used to implement the system on which this invention is used. In the typical set up shown, terminals are connected via host dial connections (not shown) to server 45 provided by a Web Service Provider that in turn accesses the Web 50 via connection 51 to a Web access server 53 and connection 61. For purposes of this embodiment, E-mail is created on either terminal 11 or 13, and sent over the Web 50 to receiving terminals 15, 19, 21.

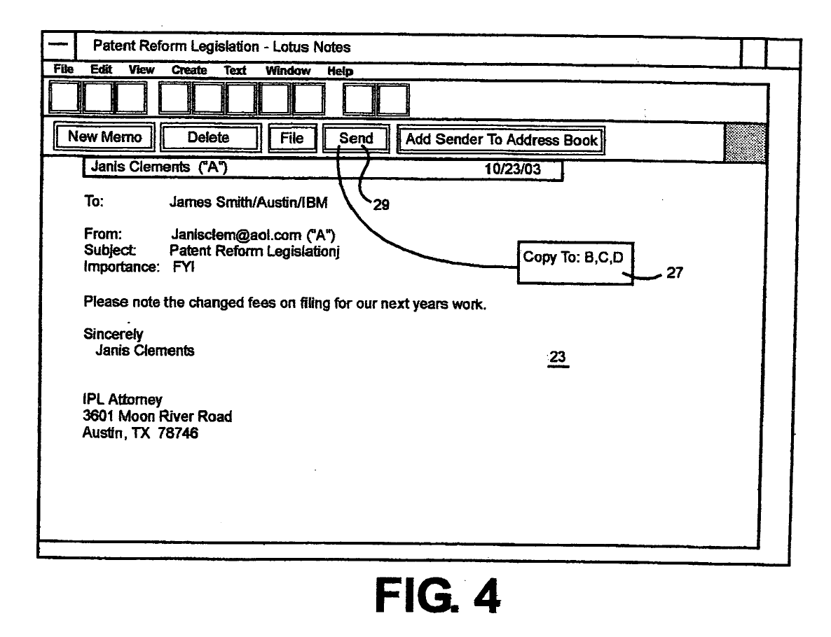

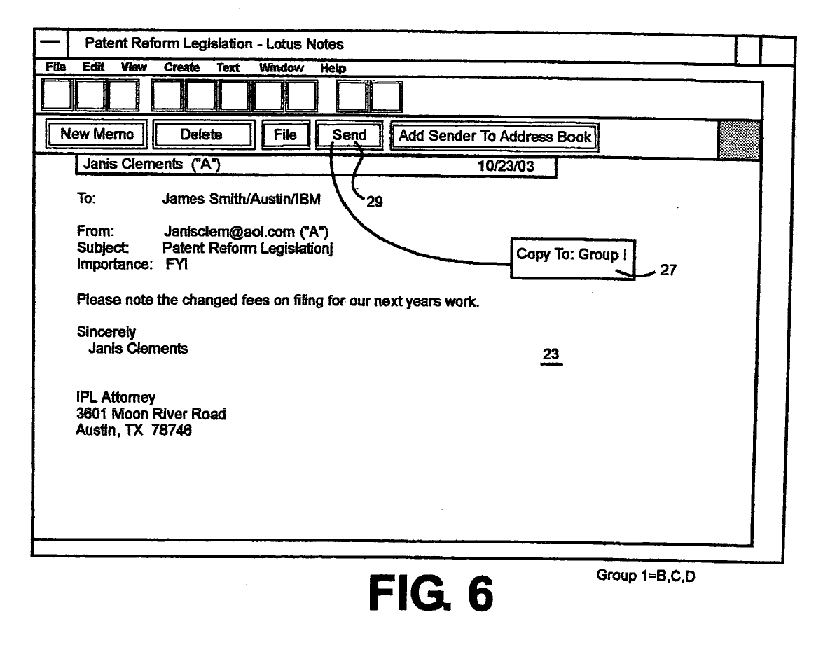

Within this E-mail network set up, we will now consider the illustrative E-mail distribution to be described with respect to FIGS. 3 through 7. In FIG. 3, there is illustrated an E-mail document or letter 23 being created by an original sender (“A”) 25 as shown in FIG. 2, e.g. E-mail 56 on sending terminals 11 or 13. When sender “A” clicks once on “Send” button 29, FIG. 3, he is prompted with display box 27, FIGS. 4 and 6, in which sender “A” is prompted to enter “Copy To:” names of individuals, i.e. those individuals to receive the E-mail document, such as “B, C, and D”, or as in FIG. 6, a distribution list, such as “Group 1”, which includes “B, C, and D”. The Send button 29 may then be clicked on again to send and distribute the E-mail document to “B, C, and D” as in FIG. 4, or as in FIG. 6, “Group 1”.

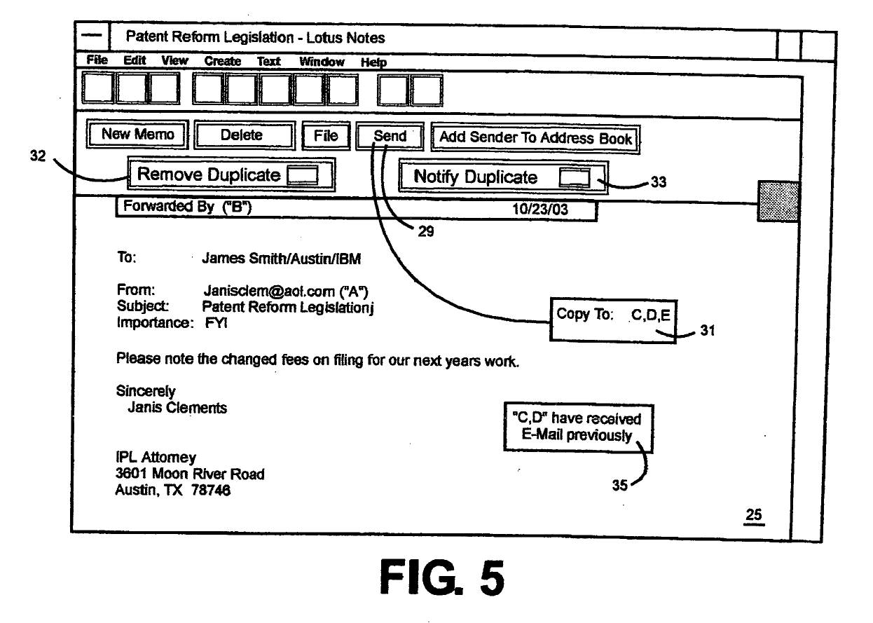

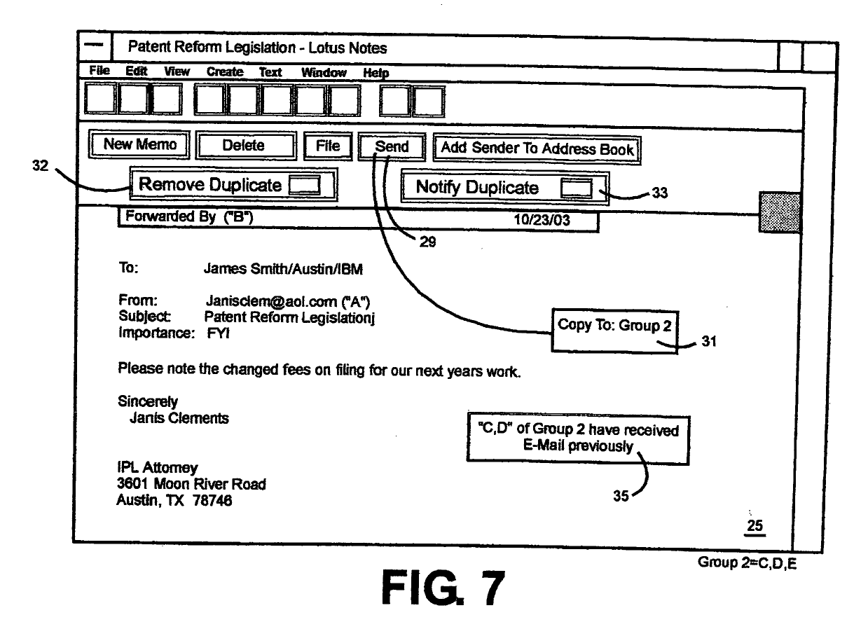

As will be described in some greater detail hereinafter, the hidden list of duplicate mail recipients or preclusion list of individuals attaches to and becomes part of the coding for the E-mail document so that it is available to preclude duplicate forwarding downstream in the E-mail document distribution cycle. Thus, as shown in FIGS. 5 and 7, when recipient “B” of the E-mail document 25 sets up the send prompt box 31 to forward an electronic document to a precluded individual, i.e., an individual who has already received the document, the forwarding will be prevented. For example, as shown in FIG. 5, the recipient of the E-mail 25, recipient “B”, has selected to forward to “C, D, and E”, and in FIG. 7, recipient “B” has selected to forward to a second distribution list, “Group 2”, which includes “C, D, and E”. In turn, for the purpose of this illustration, “C and D” have already received the E-mail from sender “A”, recipient “B” is advised in dialog box 35 that “C and D” have previously received the E-mail. Accordingly, dialog box 35 provides forwarder “B” with an inventory of duplicate mail recipients who previously received the E-mail. Forwarder “B” can select to send this duplicate E-mail 25, or “B” can have the duplicate mail automatically discarded. Forwarder “B” is provided with options “Remove Duplicate” 32 and “Notify Duplicate” 33. The “Remove Duplicate” 32 feature provides “B” with the option to discard duplicate mail to recipients who have previously received the mail. The “Notify Duplicate” option provides “B” with an inventory or list of all previous recipients of the E-mail from original sender “A” (except those who have been blind copied) and whether these recipients have been sent the E-mail by “B”.

In any standard E-mail network system, senders at display terminals are able to distribute original E-mail to specified users (i.e., recipients) or groups of users on a distribution list (reference may be made to such a distribution network as described in the text, The ABCs of Lotus Notes 4.5, R. Clayton, published by SYBEX Inc., San Francisco, 1997, particularly Chapter 18, pp. 367-398). There is also provided in the present invention at the recipient's display interfaces, means for determining whether the original E-mail document was previously sent to an individual that the recipient would like to forward the original document to. The recipient can then determine whether to forward the duplicate E-mail document to the individual or individuals who have received it previously, or discard the duplicate E-mail document. An implementation is provided wherein this “Remove Duplicate” function tracks sender “A's” document and precludes the subsequent forwarding of the document to the prohibited recipients. This may readily be done by creating a list of such prohibited recipients, “Duplicate Recipient”, and incorporating the list of addresses or equivalent appropriate identification of such prohibited recipients into the original E-mail document code as a hidden list. Accordingly, routines are provided such that the “Duplicate Recipient” or equivalent designation remains associated with sender “A's” E-mail document for the life of the document. Such routines may simply involve a check of the prohibited user list that is incorporated into the document code. Because the prohibited list follows the E-mail document and is updated each time the document is forwarded, a checking routine will be set up at the recipients of E-mail where the recipient will not be permitted to forward to a “Duplicate Recipient” individual. In such a situation, a display interface will be provided at the recipient of the E-mail who tries to forward the E-mail and will notify the recipient of the “Duplicate Recipient” status of the prohibited individual. Forwarder “B” is also provided an option of retrieving an inventory of other recipients who previously received the mail (other than blind copy recipients) and whether these other recipients were sent the mail by “B”.

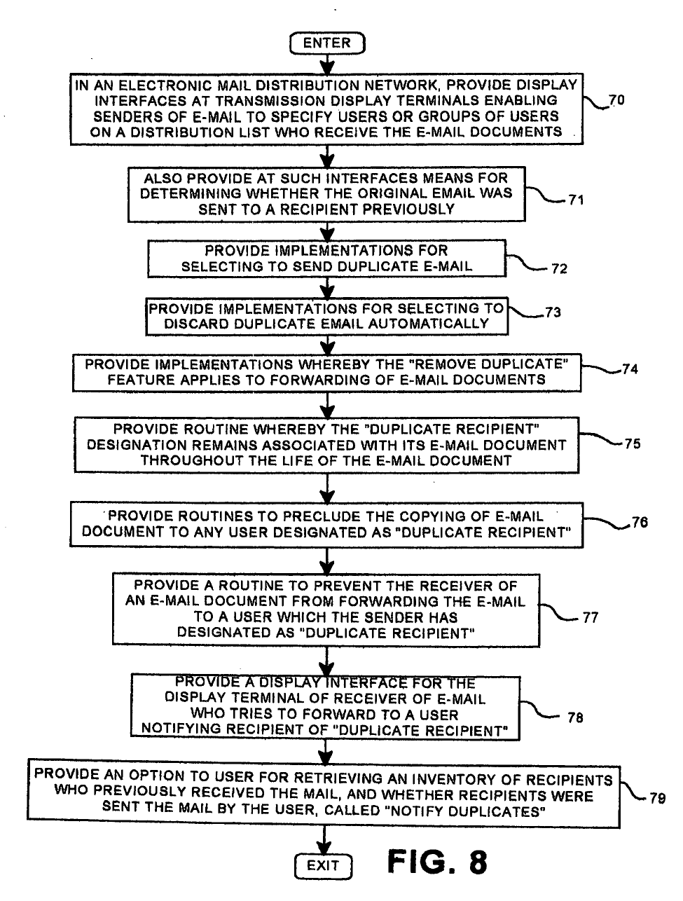

A simplified run of the process described in connection with FIGS. 3 through 7 will now be described with respect to the flowcharts of FIGS. 8 through 11. At the display terminal of the E-mail sender (i.e., “A”) in FIG. 8, there is provided an interface enabling sender “A” to indicate those individuals who are to receive the E-mail document, step 81; and the E-mail document is then sent from “A” to the designated recipients (i.e., “B, C, and D”), step 82. A hidden list of the recipients (i.e., “B, C, and D”) is created and attached to the E-mail document, step 70. The E-mail is then sent to all designated recipients (i.e., “B, C, and D”) with the attached recipient list, step 71.

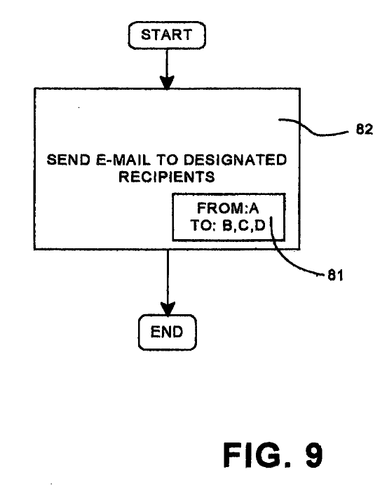

In FIG. 9, the recipients from FIG. 8 receive the original E-mail document from the FIG. 8 sender, (i.e. “A”), step 83. In particular, recipient “B” is shown in FIG. 9 as the recipient, who then decides whether to forward, step 74, the E-mail document to recipients “C, D, and E”, step 84. A determination is made as to whether to remove duplicates or not, step 85. If No, the E-mail document is forwarded to recipients “C, D, and E”, step 86. If Yes, a detection is made by “B's” server for the presence of a hidden list of recipients, step 76. If Yes, the hidden list of previous recipients is retrieved (i.e., “B, C, and D”), step 80, and the hidden list is checked for previous recipients, who are then removed from the “Forward To” address field (i.e., “C and D are removed”), step 120. If “B's” server does not detect the presence of a hidden list of previous recipients, step 76, the “To” address field is retrieved (i.e., “B, C′ and D”), step 77, and previous recipients of the E-mail document are removed from the “Forward To” address field (i.e., “C and D are removed”), step 78. Then new recipients (i.e., “C, D, and E”) are added to the hidden list of previous recipients to form a new hidden list (i.e., “B, C, D, and E”), step 79, which will attach to and travel with the E-mail document as the E-mail is forwarded to designated recipients who have not previously received the E-mail document, step 88. This hidden list will continue to be updated with new recipients each time the document is forwarded.

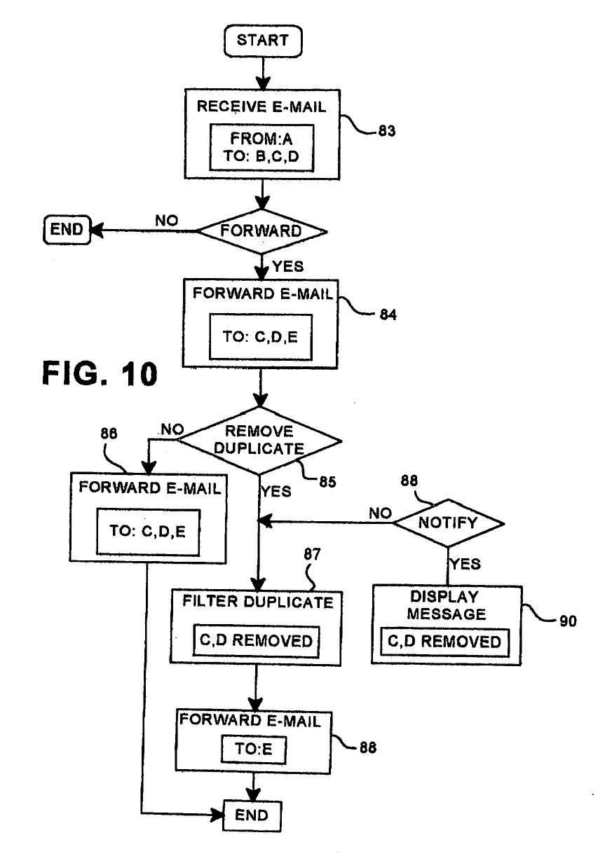

At the display terminal of the E-mail sender in FIG. 10, there is provided an interface enabling the sender (i.e., “A”) to indicate those distribution lists containing individuals who are to receive the document, step 91; and the E-mail document is then sent to the designated recipient groups (i.e., Group 1″), step 92. A hidden list of previous recipients from a distribution list (i.e., “B, C, and D”) is created and attached to the E-mail document, step 72. The E-mail document with the hidden list of previous recipients attached thereto, is forwarded to all designated recipients (i.e., “B. C, and D”), step 73.

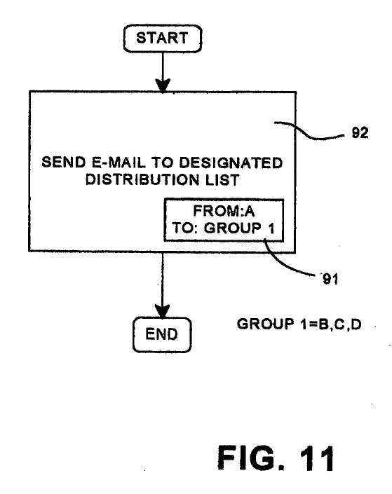

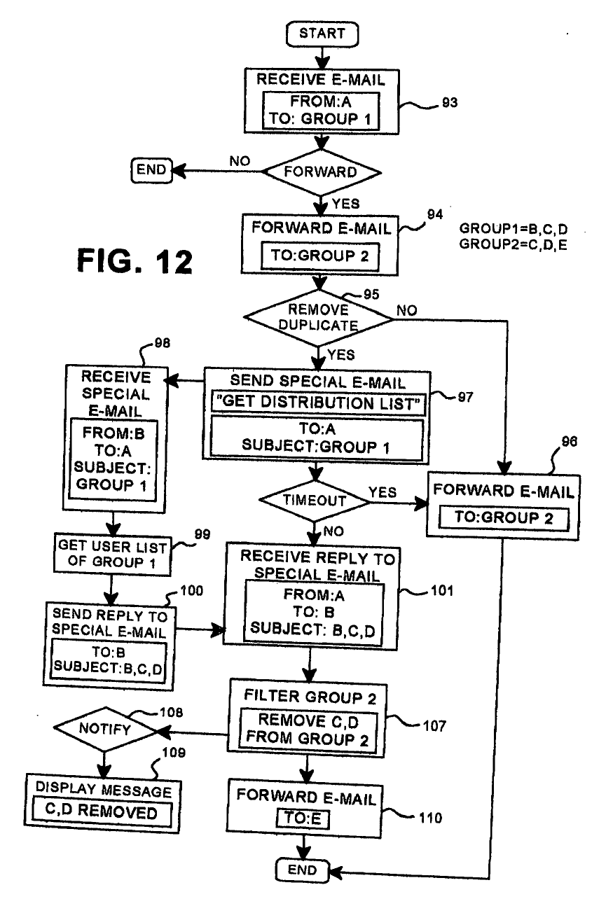

In FIG. 11, the recipients in Group 1 from FIG. 10 (i.e., “B, C, and D”) receive the original E-mail document from the FIG. 10 sender (i.e., “A”), step 93. By way of example, recipient “B” is shown in FIG. 11 as the recipient, who then determines whether to forward the E-mail document, step 122, to recipients in a different distribution list (i.e., “Group 2”), step 94. When “B” attempts to forward the E-mail document to Group 2, which includes recipients “C, D, and E”, step 94. There is a feature wherein “B” can set the system to automatically delete duplicate recipients (not shown). As illustrated in FIG. 11, a determination is made by “B” as to whether to remove duplicates or not, step 95. If No, the E-mail document is forwarded to the recipients of Group 2, step 96. If Yes, then a detection is made “B's” E-mail server for the presence of a “hidden list” of recipients who previously received the E-mail document (i.e., “C and D”), step 124. If No, the E-mail is forwarded to the designated recipients (i.e., “Group 2” or “C, D, and E”), step 96. If Yes, a hidden list is retrieved of the recipients who have previously received the document (i.e., “B, C, and D”), step 125. Then these recipients (i.e., “B, C, and D”) are removed for the “Forward To” address field of the E-mail document (i.e., “C and D are removed from Group 2”), step 126. A new hidden list is then formed with the addition of new recipients to whom the document has previously been sent or is currently being forwarded (i.e., “B, C, D, and E”), step 127, which attaches to the document and travels with it as it is forwarded to designated recipients of the distribution list (i.e., “Group 2”) who have not previously received the document (i.e., “E”), step 110. New recipients are added to the hidden list to continuously update it as the document is forwarded.

One of the preferred implementations of the present invention is in application program 40 made up of programming steps or instructions resident in RAM 14, FIG. 1, of Web server computers during various Web operations. Until required by the computer system, the program instructions may be stored in another readable medium, e.g. in disk drive 20, or in a removable memory, such as an optical disk for use in a CD ROM computer input, or in a floppy disk for use in a floppy disk drive computer input. Further, the program instructions may be stored in the memory of another computer prior to use in the system of the present invention and transmitted over a Local Area Network (LAN) or a Wide Area Network (WAN), such as the Internet, when required by the user of the present invention. One skilled in the art should appreciate that the processes controlling the present invention are capable of being distributed in the form of computer readable media of a variety of forms.

Although certain preferred embodiments have been shown and described, it will be understood that many changes and modifications may be made therein without departing from the scope and intent of the appended claims.

1. In a communication network with user access via a plurality of data processor controlled interactive display terminals, an electronic mail distribution system for mail transmitted between said terminals, comprising:
a display interface at a sending terminal, including:
(a) means enabling a sender of an original electronic mail document to specify one or more recipients to receive the document;
(b) means enabling the sender to create a hidden list of the recipients within the document;
(c) means enabling a forwarder of the document to determine if the document has been previously delivered to the one or more of the recipients;
(d) means enabling the forwarder of the document to update the hidden list of recipients with new recipients; and
(e) means enabling the forwarder of the document to select to send or discard a duplicate document.

2. The communication network of claim 1 wherein the sender of the original electronic mail document specifies a first group of recipients in a first distribution list as the recipients to receive the document.

3. The communication network of claim 2 wherein a recipient from the first group of recipients in the first distribution list forwards the electronic mail document to a second group of recipients in a second distribution list.

4. The communication network of claim 1 wherein the means (c) comprises an inventory of duplicate mail recipients for the electronic mail document is provided to a forwarder of the electronic mail document.

5. The communication network of claim 1, further including means for automatically discarding the duplicate electronic mail document.

6. The communication network of claim 1 further including means for precluding recipients who previously received the original electronic mail document from receiving the forwarded document from another sender.

7. In an electronic mail distribution network with user access via a plurality of data processor controlled interactive display terminals, an electronic mail distribution method for mail transmitted between said terminals comprising:
(a) displaying an electronic mail document to be sent at a sending terminal;
(b) enabling a sender of the electronic mail document to specify one or more recipients to receive the document;
(c) enabling the sender to create a hidden list of the recipients within the document;
(d) enabling a forwarder of the document to determine if the document has been previously delivered to the one or more recipients;
(e) enabling the forwarder of the document to update the hidden list of recipients with new recipients; and
(f) enabling the forwarder of the document to select to send or discard a duplicate document.

8. The communication network of claim 7 further including the step of the sender of the original electronic mail document specifying a first group of users in a first distribution list as the recipients to receive the document.

9. The communication network of claim 8 further including the step of a recipient from the first group of users in the first distribution list forwarding the electronic mail document to a second group of users in a second distribution list.

10. The communication network of claim 7 further including the step of providing an inventory of duplicate mail recipients for the electronic mail document to a forwarder of the electronic mail document.

11. The communication network of claim 7, further including the step of automatically discarding the duplicate electronic mail document.

12. The communication network of claim 7 further including the step of precluding recipients who previously received the original electronic mail document from receiving the forwarded document from another sender.

13. A computer program having code recorded on a computer readable medium for distribution of electronic mail in an electronic mail distribution network with user access via a plurality of data processor controlled interactive display terminals, said computer program comprising:
a display interface at a sending terminal, including:
(a) means enabling a sender of an original electronic mail document to specify one or more recipients to receive the document;
(b) means enabling the sender to create a hidden list of recipients within the document;
(c) means enabling a forwarder of the document to determine if the document has been previously delivered to the one or more recipients;
(d) means enabling the forwarder of the document to update the hidden list of recipients with new recipients; and
(e) means enabling the forwarder of the document to select to send or discard a duplicate document.

14. The communication program of claim 13 wherein the sender of the original electronic mail document specifies a first group of users in a first distribution list as the recipients to receive the document.

15. The communication program of claim 14 wherein a recipient from the first group of users in the first distribution list forwards the electronic mail document to a second group of users in a second distribution list.

16. The communication program of claim 13 wherein an inventory of duplicate mail recipients for the electronic mail document is provided to a forwarder of the electronic mail document.

17. The communication program of claim 13, further including means for automatically discarding the duplicate electronic mail document.

18. The communication program of claim 13 further including means for precluding recipients who previously received the original electronic mail document from receiving the forwarded document from another sender.
